(19) United States
(12) Patent Application Publication
(10) Pub. No.: US 2016/0322695 A1
(43) Pub. Date: Nov. 3, 2016

(54) ROTARY CONTROL WITH INTEGRATED ANTENNA

(71) Applicant: MOTOROLA SOLUTIONS, INC, SCHAUMBURG, IL (US)

(72) Inventors: PATRICK S. CLAEYS, PEMBROKE PINES, FL (US); ANTONIO FARANO, FORT LAUDERDALE, FL (US); GIORGI BIT-BABIK, PLANTATION, FL (US); JODY H. AKENS, WESTON, FL (US); JONATHAN D. STEINBERG, BOYNTON BEACH, FL (US)

(21) Appl. No.: 14/700,684

(22) Filed: Apr. 30, 2015

(51) Int. Cl. H01Q 1/12

(52) U.S. Cl. CPC H01Q 1/125

(57) ABSTRACT

A rotary control (102) having an antenna radiating element (202) integrated therein is provided. The rotary control (102) is formed of a knob housing (112) providing an axis of circumferential rotation (120). The antenna radiating element (202) is rotatable along the axis of circumferential rotation (120) in response to rotation of the knob housing (112). The antenna radiating element (202) is coupled to a rotatable antenna feed electrode (230). The rotary control (102) having the integrated antenna radiating element (202) may be mounted to a communication device housing having a stationary capacitive feed electrode (220). The stationary capacitive feed electrode (220) and rotatable antenna feed electrode (230) provide capacitive coupling for the transfer of RF signals to and from antenna radiating element (202) regardless of the position of rotation of the knob housing (112).

### FIELD OF THE DISCLOSURE

The present invention relates generally to antennas and more particularly to antennas for portable and mobile communication devices.

### BACKGROUND

Portable and mobile (vehicular) communication devices continue to be challenged by the need to incorporate many features into a single device without impacting the overall size or ease of access to existing user interface features. Communication devices, such as two-way radios, particularly those operated in the public-safety arena may require the ability to operate over different frequency bands thus requiring more than one antenna. However, the addition of a separate antenna to a portable radio control top or mobile radio control head may impact access to user interface features, such as rotary controls. The ability to maintain access to the user interface features is important to radios being operated in public safety environments such as law enforcement, fire rescue and others that may encounter poor visibility conditions, harsh weather environments, or gloved usage conditions. Hence, a new antenna structure should minimize impact on the physical user interface of the radio device. Overall complexity, likewise impacts cost and ease of manufacturability and thus should also be considered when developing a new antenna structure.

Accordingly, it is desirable to provide an antenna structure that can be incorporated into a radio product while maintaining the physical radio user interface.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a radio having a rotary control incorporating an antenna formed in accordance with some embodiments.

FIG. 2 shows a partially exploded view of a rotary control incorporating an antenna structure in accordance with some embodiments.

FIG. 3 shows a partial view of the radio side upon which to mount a rotary control formed in accordance with some embodiments.

FIG. 4 shows a cross-sectional view of a rotary control incorporating the antenna structure mounted to the radio in accordance with some embodiments.

FIG. 5 is a partial view example of a rotary control incorporating an antenna structure in accordance with some embodiments.

FIG. 6 shows another example of a rotary control incorporating an antenna structure in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Briefly, there is provided herein a rotary control having an antenna structure integrated therein. The rotary control is formed of a knob housing providing an axis of circumferential rotation. An antenna radiating element, located within the knob housing, rotates about the axis of circumferential rotation in response to rotation of the knob housing. A rotatable capacitive feed electrode is coupled to the antenna radiating element. Rotation of the rotary control rotates the antenna radiating element having the rotatable antenna feed electrode coupled thereto.

The antenna radiating element may be disposed in the knob housing or formed on or within a substrate conforming to the interior of the knob housing. The rotary control having the antenna integrated therein may be assembled to a radio control top having a stationary capacitive feed electrode situated thereon. The stationary capacitive feed electrode provides capacitive coupling for the transfer of RF signals to and from the rotatable capacitive feed electrode and the antenna radiating element. The capacitive coupling between the stationary capacitive feed electrode and the rotatable antenna feed electrode is maintained regardless of the position of rotation of the rotary control.

The rotary control having integrated antenna allows for the control of at least one radio user interface function in addition to the one or more operational frequencies provided by the antenna radiating element. Thus, transmission and reception of RF signals can take place via the antenna radiating element while the rotary control is operated as a radio control function.

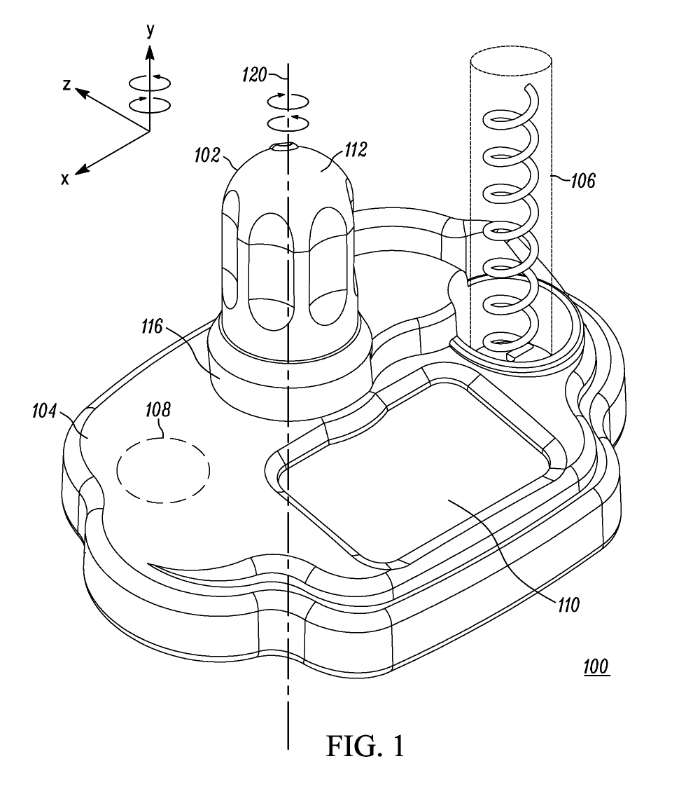

FIG. 1 is a radio 100 having a rotary control 102 incorporating an antenna formed in accordance with some embodiments. Rotary control 102 comprises a knob housing 112 situated on a control top 104 of radio 100 and within which is embedded the antenna. The control top 104 may further comprise other radio features such as another antenna 106, additional knobs and/or button(s) 108 and/or additional interface items such as a display 110 to name a few. In accordance with the various embodiments, rotary control 102, in addition to having an antenna integrated therein, also controls at least one other radio function such as channel change, volume adjustment, power on/off, or other suitable radio control function. The incorporation of the antenna within the rotary control 102 allows the user interface of control top 104 to be maintained, even within limited space constraints, while allowing the antenna to operate in a suitable portion of the radio.

In accordance with the various embodiments, the knob housing 112 of rotary control 102 rotates about an axis of circumferential rotation 120 which in turn rotates the internal antenna structure, as will be described in conjunction with other figures. For the purposes of illustration, a circumferential rotation about a y-axis (of an x-y-z coordinate system) is shown with the understanding that the rotary control 102 could be placed on a different surface of the radio 100, for example a front surface of a vehicular mobile radio.

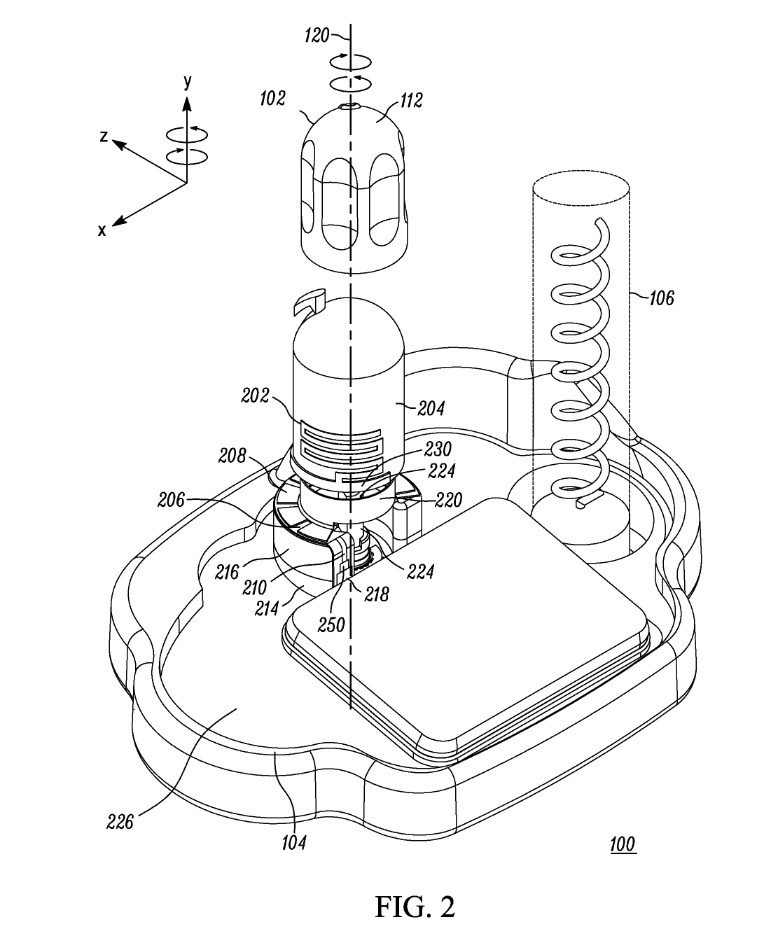

The knob housing 112 is formed of non-conductive materials, such as low-loss dielectric plastics. In this embodiment the knob housing 112 is seated upon a stationary bezel 116. The bezel 116 provides a cover within which electrical/mechanical interface components may be housed, as will be shown and described in FIG. 2. Alternatively, electrical/mechanical interface components may be located beneath the control top 104 thus allowing for the elimination of the bezel 116. The bezel 116, if used, may likewise be made out of non-conductive materials, such as low-loss dielectric plastics or similar materials. For public safety type radios, the surface of the knob housing 112, the control top 104 and the bezel 116 might be formed, for example, of ruggedized thermoplastics such as those formed via overmolding or other similar processes.

Although not shown, it is understood that radio 100 further comprises internal electronics, such as a receiver, a transmitter and a controller for handling radio communications, such as two-way communications, which may require operation over more than one frequency band. By incorporating additional antenna(s) into the rotary control, additional frequency bands of operation are now obtainable (e.g. dual-band, multi-band) without impacting the physical user interface of the control top 104.

In accordance with the various embodiments, the rotary control 102 incorporating the antenna facilitates extending functionality of the radio without negatively impacting the physical user interface. Extended frequency bands can be added through the additional antenna(s) integrated within the rotary control 102, while a plurality of other controls, present on the control top 104, provide other user interface features. For example rotary control 102 having antenna integrated therein may operate over Long-Term Evolution (LTE) and GPS bands, while the second radio antenna 106 may provide coverage over such bands as VHF (136-174 MHz), UHF (380-520 MHz), or 764-869 MHz.

While the rotary control 102 incorporating the antenna is particularly beneficial for the handheld, portable two-way radio market, it is understood that the benefits derived therefrom also apply to vehicular mobile radios where the controls and user interface items are typically situated on a so-called control head. And while particularly beneficial to the public safety communications market, the rotary control 102 providing one or more antennas can also be implemented in communication products that offer a plurality of controls and user interface features within limited space constraints.

FIG. 2 shows a partially exploded view of the rotary control 102 incorporating an antenna structure in accordance with some embodiments. In this view, the knob housing 112 of rotary control 102 has been removed to expose an antenna radiating element 202 disposed on a substrate 204 in accordance with some embodiments. In accordance with some embodiments, the substrate 204 is shaped to conform to an interior surface of the knob housing 112. A rotatable antenna feed electrode 230 is coupled (galvanically attached in the pictorial representation of FIG. 2) to the antenna radiating element 202, the rotatable antenna feed electrode being concentric with the axis of circumferential rotation 120.

The bezel 116 of FIG. 1 is not shown in FIG. 2 so as to view the elements hosted therein. As mentioned previously these elements may be hosted beneath the control top 104 within the radio if no bezel is used. A non-conductive platform 216 may be attached to a metal shelf 214 extending from radio chassis 226. The metal shelf 214 may be attached to (or formed as part of) the radio chassis 226 and therefore provides a ground (GND) reference for antenna radiating element 202. The control top 104 hosts a radio frequency (RF) feed line 210. The RF feed line 210 comes from the radio and couples to a stationary capacitive feed electrode 220 that sits on the non conductive platform 216. The RF feed line 210 may comprise a flex substrate 206 having at least one solder pad to connect to the stationary capacitive feed electrode 220, which may feature supports 208 disposed around the perimeter of feed electrode 220 on top of flex 206 and platform 216. At least one support 208 is coupled (e.g., soldered) to feed line 210. Other known suitable means to provide RF signal to feed electrode 220, for example through a coaxial cable (not shown) are possible. The RF feed line 210 may further comprise impedance matching circuitry 250, for example adjacent to the RF feed point 218.

The non-conductive platform 216 provides a distance between the stationary capacitive feed electrode 220 and the ground reference (GND) provided by the metal shelf 214. Thus, the stationary capacitive feed electrode 220 may not be galvanically connected to the metal chassis. However there may be instances where a galvanic connection to ground is advantageous, because it provides a shunt current path that may provide desired input impedance characteristics. Said galvanic connection may be realized, for instance, by inserting a metal screw through one support 208 all the way to a threaded hole in shelf 214.

The stationary capacitive feed electrode 220 is fixed and non-rotating. In accordance with the embodiments, the stationary capacitive feed electrode 220 capacitively couples with the rotatable antenna feed electrode 230 to transfer RF signals to and from the antenna radiating element 202. The stationary capacitive feed electrode 220 and rotatable antenna feed electrode 230 at least partially overlap to provide a sufficiently large capacitance relative to possible variations due to mechanical tolerances. The stationary capacitive feed electrode 220 and the rotatable antenna feed electrode 230 form a substantially constant capacitance therebetween, independent of knob position. Thus, as the rotary control 102 is rotated for its radio function, such as for volume control or channel change, the capacitive coupling is maintained between the antenna feed electrode 230 and stationary capacitive feed electrode 220 thereby allowing RF signals to transfer to and from antenna radiating element 202.

Rotation of the knob housing 112 rotates via a rotary shaft 224, embedded within substrate 204. A portion of the stationary capacitive feed electrode 220 may be shaped as a cylinder or ring (or partial cylinder/partial ring) that is concentric with the axis of circumferential rotation 120 of the knob housing 112.

The rotary control of the embodiments is easily manufactured and assembled. For example, the substrate 204 may be formed as a first thermoplastic piece part and the knob housing 112 may be formed of a second thermoplastic piece part via overmolding processes (such as injection molding and/or compression molding). The antenna radiating element 202 may be disposed on to the substrate 204 via a variety of techniques such as laser direct structuring (LDS), plating, etching and stamping techniques to name a few. The knob housing 112 may be assembled to the substrate 204 via snap fit, glue, molded or bonded assembly means.

In an alternative embodiment, the antenna radiating element 202 may be disposed within the substrate 204, the substrate being a non-follow substrate. In an alternative embodiment, the antenna radiating element 202 may be disposed on a surface of the knob housing 112, such as the interior surface. In another alternative embodiment, a single knob housing may be molded as a unitary molded piece part having the antenna radiating element 202 and the antenna feed electrode 230 located therein. In accordance with the embodiments, the antenna radiating element 202 and the rotatable antenna feed electrode 230 are located within the knob housing 112 such that the antenna rotates along the same axis of circumferential rotation as that of the knob housing. In another alternative embodiment, the rotatable antenna feed electrode 230 may be a small planar tab that extends from the antenna radiating element 202 within a predetermined proximity to the stationary capacitive feed electrode 220, and when antenna is rotated this predetermined proximity is maintained for all positions of the knob and maintains capacitive coupling therebetween. Some embodiments may have the RF feed line coupled to metal plate 214, without the use a platform.

Depending on the configuration of the knob housing 112, the shaping of the substrate 204, the shaping of the stationary capacitive feed electrode 220 and the shaping of the rotatable antenna feed electrode 230 can be modified to configure thereto. For example, rather than being cylindrical, the stationary capacitive feed electrode 220 and the rotatable antenna feed electrode 230 may be shaped as flanged circles, partially flanged circles, planar rings, partial planar rings, or combinations thereof, to name a few. For knobs which do not rotate a full 360 degrees, it is not required to have a full circular ring or cylinder shape. In accordance with some embodiments, the shaped configuration of the stationary capacitive feed electrode 220 and the rotatable antenna feed electrode 230 are formed to be concentric and overlapping throughout the degree of rotation of the knob thereby maintaining substantially constant capacitive coupling.

The feeding structure provided by the overlapping stationary and rotatable circumferential rings or cylinders allows for a variety of antenna radiator elements to be implemented within the rotary control 102. In this embodiment, the antenna radiating element 202 is shown as a meandered monopole, however other configurations for example, single-pitch or variable-pitch helical, linear monopole, or any arbitrarily shaped monopole antenna, can be used. As shown later, it is also possible to implement a bifilar antenna structure featuring favorable up-tilted radiation pattern characteristics which may be particularly desirable for maintaining reliable satellite links, e.g., with the GPS satellite constellation.

In transmit mode, RF signals from the radio are coupled from an RF feed point 218 to the RF feed line 210 (through matching circuit 250 if present) then to the stationary capacitive feed electrode 220 which capacitively couples to the rotatable antenna feed electrode 230, which is then coupled to antenna radiating element 202 for transmission. In receive mode, RF signals received at antenna radiating element 202 are capacitively coupled from the rotatable antenna feed electrode 230 to the stationary capacitive feed electrode 220 which are then transferred via RF feed line 210 to the radio RF feed point 218 (through matching circuit 250 if present). The overlap between the stationary capacitive feed electrode 220 and antenna radiating element 202 provides the electromagnetic capacitive coupling for RF signals to be transferred to/from the radio 100.

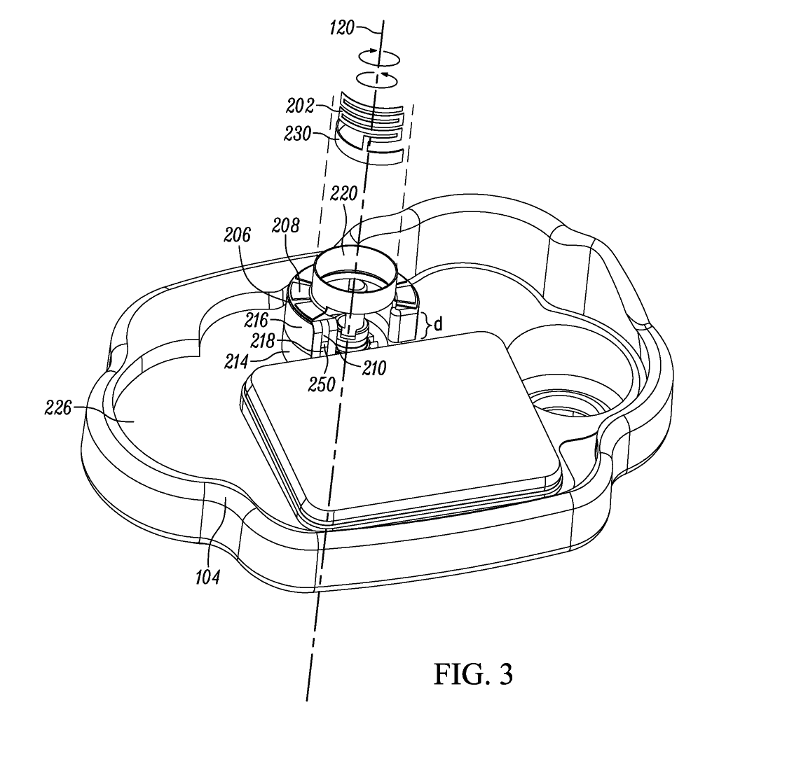

FIG. 3 shows a partial view of the radio side upon which to mount the rotary control formed in accordance with some embodiments. This view shows the control top 104 with chassis 226, non-conductive platform 216, RF feed line 210 and stationary capacitive feed electrode 220 in accordance with some embodiments. The rotary control components of antenna radiating element 202 with rotatable antenna feed electrode 230 attached thereto are shown (without the substrate or knob housing) to illustrate general alignment of the stationary capacitive feed electrode 220 and the rotatable antenna feed electrode 230.

The stationary capacitive feed electrode 220 comprises a fixed, non-rotating, capacitive metal electrode formed as a cylinder or ring (or partial cylinder/partial ring) that is concentric with the axis of circumferential rotation 120 of the knob housing 112 and antenna radiating element 202. The antenna radiating element 202 having rotatable antenna feed electrode 230 attached thereto is shown without a substrate to illustrate the concentric shaping when assembled within or around the stationary capacitive feed electrode 220. The overlap and concentric shaping provides capacitive coupling about the axis of circumferential rotation 120.

Stationary capacitive feed electrode 220 may further comprise features, such as tabs, snaps and the like, which enable robust physical attachment to the non-conductive platform 216. The RF feed line 210 is coupled to the stationary capacitive feed electrode 220 via supports 208 (or other coax type interconnect). The non-conductive platform 216 may be attached to the control top with screws that could provide a ground reference for the RF feed line 210 via one or more supports 208 and corresponding metal screws. Matching components 250 may be mounted to the flex 206. The non-conductive platform 216 operates as a spacer providing a distance “d” between the stationary capacitive feed electrode 220 and metal shelf 214 ground reference (GND), which is coupled to chassis 226 if the latter is metallic to form a contiguous ground structure. Although the non-conductive platform 216 is considered non-conductive it can be attached to the control top with screws that could provide a ground reference for the feed line or matching components.

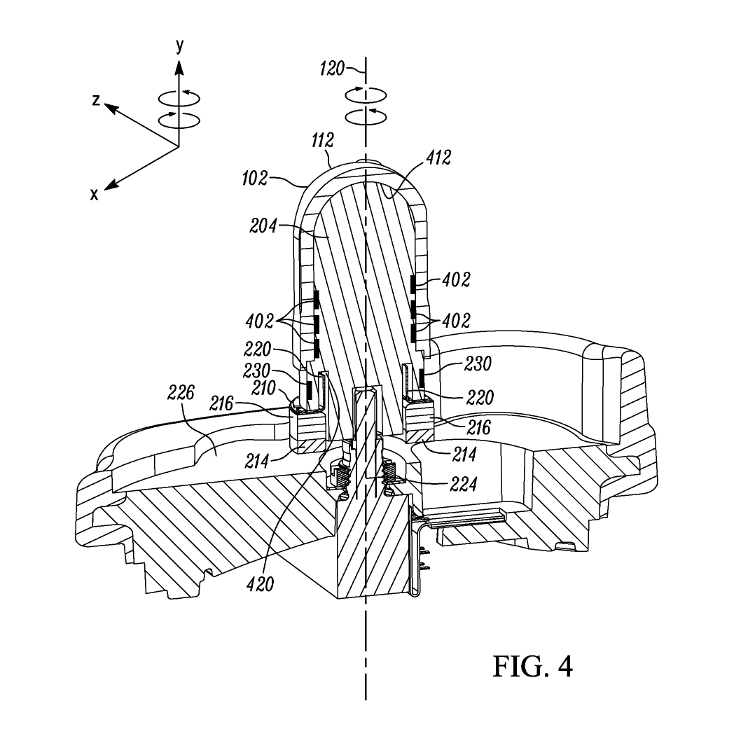

The stationary capacitive feed electrode 220 may be formed as part of, or separately from, the non-conductive platform 216. The stationary capacitive feed electrode 220 may be located outside of the substrate 204 or positioned higher up within a cut-out (as will be described in FIG. 4) of the rotating substrate 204, depending of the positioning of the antenna radiating element 202 and antenna feed electrode 230.

In accordance with some embodiments, the rotatable antenna feed electrode 230 is concentric and at least partially overlapping with the stationary capacitive feed electrode 220. In another embodiment, the rotatable antenna feed electrode and the stationary capacitive feed electrode may be overlapping and planar to each other. The two electrodes (rotating and non-rotating) can be formed in a variety of shapes, angles and planes however in order to achieve the capacitive coupling the two electrodes feature mating surfaces that are typically parallel to each other at all points of overlap.

As it can be readily deduced from FIGS. 2 and 3, substrate 204 may host multiple meander antennas, which may share the same rotatable antenna feed electrode 230 or have separate feed electrodes.

Again, the additional antenna(s) provided by rotary control 102 advantageously provide the additional frequency bands of coverage without impacting user interface features such as channel change, volume control, display, emergency button, to name a few. The details of the antenna structure itself are described next.

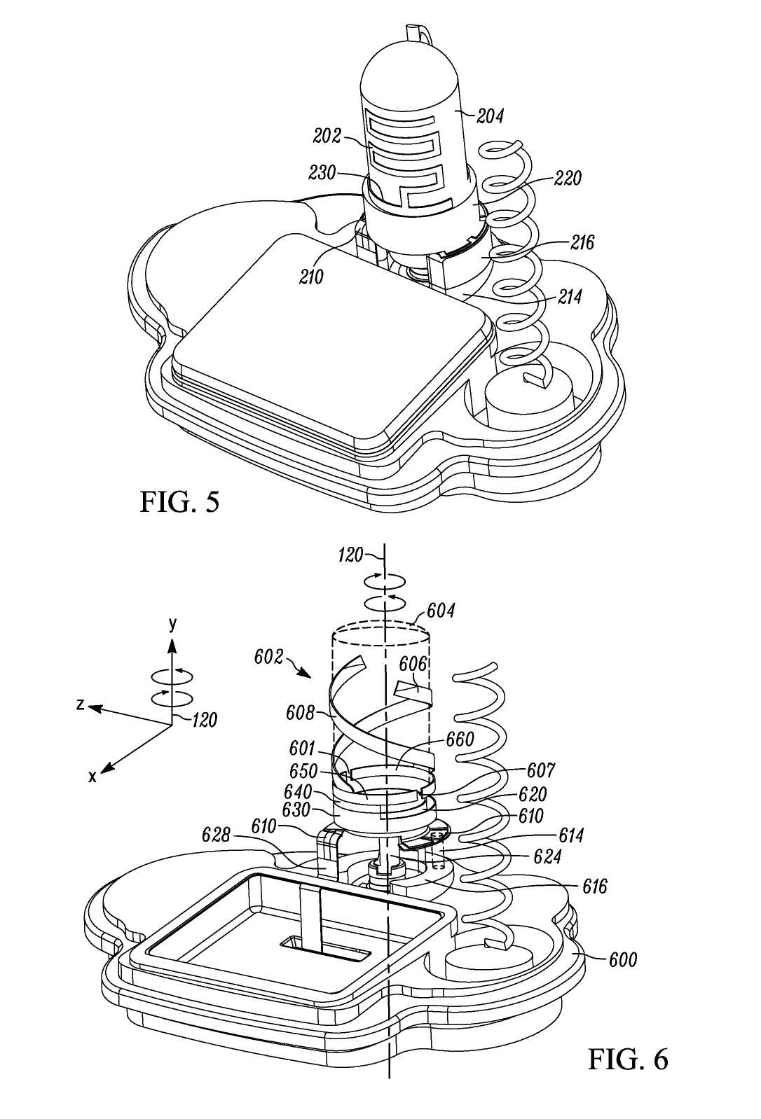

FIG. 4 shows a cross-sectional view of a rotary control incorporating an antenna structure mounted to the radio in accordance with some embodiments. In accordance with this embodiment, the substrate 204 is molded to fill and conform to an interior surface 412 of the knob housing 112. An antenna radiating element 402, shown in this embodiment as a helix, is deposited onto substrate 204 against an interior surface 412 of the knob housing 112. The rotatable antenna feed electrode 230, in this embodiment, is similarly deposited onto substrate 204 against the interior surface 412 of the knob housing 112. The stationary capacitive feed electrode 220 is shown here as being located within a cut-out or slot 420 formed within the substrate 204. Alternatively, the stationary capacitive feed electrode 220 may be located outside of the substrate 204 as will be shown in FIG. 5. The stationary capacitive feed electrode 220 is fixed and attached to the RF feed line 210 which is mounted upon non-conductive platform 216 mounted to metal shelf 214.

In accordance with some embodiments, rotation of the knob housing 112 about the axis of circumferential rotation 120 causes rotation of the substrate 204 and the antenna radiating element disposed thereon as well as the rotatable antenna feed electrode 230. The rotatable antenna feed electrode 230 is capacitively coupled to the stationary capacitive feed electrode 220 regardless of the rotation of the rotary control 102.

The stationary capacitive feed electrode 220 and the rotatable antenna feed electrode 230 may be configured as a partial or full circular or cylindrical shape. Other embodiments may also comprise planar circular or partially-circular shapes. The stationary capacitive feed electrode 220 is configured to overlap and be concentric with the rotatable antenna feed electrode 230 to ensure appropriate capacitive coupling through the range of rotation of the rotary control 102. The range of rotation, as discussed previously is dependent on the rotation set for the knob's radio function, such as volume, channel change or other function.

From a materials and process perspective, the substrate 204 may be formed, for example, via a first shot overmolding process. The deposition of the antenna radiating element 402 can be achieved through either LDS (or similar technology) or through the use of heat staked, overmolded, or otherwise attached material capable of carrying RF currents. For example, printed, plated, and stamped sheet metal antenna radiating elements can be deposited on or into the plastic. The knob housing 112 may be formed by a second shot overmolding process. The antenna radiating element 402 could alternatively be deposited on or within the knob housing 112 as part of the second shot process. The substrate 204 and knob housing 112 may be molded of a polymer, elastomer, or other thermoplastic material. The entire assembly of knob housing 112 and substrate 204 can thus be formed as a single plastic piece part with the antenna radiating element 402 embedded therein.

Alternatively, the substrate 204 and knob housing 112, if formed as separate piece parts, may be assembled together using glue, snap-fit interface, or other attachment means.

Unlike antennas that have put the antenna radiating element on a printed circuit board, the use of molded plastic parts whether overmolded or assembled together provides the advantage of design flexibility and precision.

FIG. 5 is a partial view example of the rotary control incorporating the antenna structure in accordance with some embodiments. The knob housing 112 has been removed in this view to expose the antenna radiating element 202 disposed on substrate 204 along with rotatable antenna feed electrode 230 and stationary capacitive feed electrode 220.

As previously described, the RF feed line 210 comes from the radio and couples to the stationary capacitive feed electrode 220 that sits on the non conductive platform 216. In this embodiment, the stationary capacitive feed electrode 220 is located outside of the substrate 204 and coupled to the RF feed line 210, for example via a solder connection or other connection (not shown). The rotatable antenna feed electrode 230 may be configured as a partial or full cylindrical shape. The stationary capacitive feed electrode 220 is configured to overlap and be concentric with the rotatable antenna feed electrode 230 to ensure appropriate capacitively coupling through the range of rotation of the knob housing 112 (shown in other views). Unlike the embodiment of FIG. 4, the stationary capacitive feed electrode 220 of FIG. 5 is located exterior to the rotatable antenna feed electrode 230, the former surrounding the latter. The range of rotation, as mentioned previously is dependent on the rotation set for the knob's radio function, such as volume, channel change or other function.

The various embodiments have shown that the stationary capacitive feed electrode 220 can be placed in more than one location (for example within substrate or outside of substrate), as well as be interior or exterior relative to the rotatable antenna feed electrode 230, and still provide reliable capacitive coupling to the rotatable antenna feed electrode 230. Additionally, if a single plastic piece part is used to realize the rotating portion of the knob (comprising substrate 204 and knob housing 112) then the ensuing molded knob is formed with embedded antenna radiating element and appropriate cut-aways for accommodating the stationary capacitive electrode situated on the non-conductive platform 216. Additionally, the stationary capacitive feed electrode 220 and the rotatable antenna feed electrode 230 may alternatively be configured as partial or full parallel, planar circular shapes overlapping to each other.

FIG. 6 shows a bifilar antenna radiating element and exposed capacitive feed situated on a control top in accordance with some embodiments. Bifilar antennas provide better hemispherical coverage than meandered, helical, or other monopole-like antennas which typically feature radiation nulls towards the top and bottom hemispheres. Moreover, bifilar antennas produce a radiation pattern that is predominantly circularly polarized, which is advantageous for communications with satellite-based networks such as GPS.

While the previous embodiments have shown an antenna radiator element configured as a meandered monopole, in this embodiment a bifilar antenna 602 is provided having first and second bifilar antenna arms 606 and 608. Unlike conventional single-feed bifilar antennas which require a balun to produce a differential feed to be applied to the bifilar antenna arms 606 and 608, the differential antenna arms excitation is achieved here through a suitable coupling mechanism between arms 606 and 608, as further described below. Gaps 601, 607 between bifilar antenna arms 606 and 608 control phasing capacitances. A continuous feed trace, along attached at the base of the arms, operates as a rotatable antenna feed electrode 630.

In this embodiment, the rotatable antenna feed electrode 630 is situated outside of a stationary capacitive ring electrode 620. The stationary capacitive ring electrode 620 is coupled to an RF feed line 610 which transfers RF signals to/from a radio at RF feed 628. RF feed line 610 may be screwed 616 or otherwise coupled to metal plate 614, for example in embodiments that do not use a platform. The stationary capacitive ring electrode 620 capacitively couples the rotatable antenna feed electrode 630 for transfer of RF signals to and from the arms of antenna 602. The rotatable antenna feed electrode 630 may be shaped as a cylinder or ring (or partial cylinder/partial ring) that is concentric with the axis of circumferential rotation 120 of the knob housing 112, and it extends vertically through an additional section 640 coupled thereto which in turns is coupled (e.g. galvanically connected) to a first phasing section 650. First phasing section 650 may be a partial cylinder wrapped around about half the circumference of the horizontal cross section of substrate 604.

The first bifilar antenna arm 606 is coupled to the first phasing section 650, and it is realized/mounted on the surface of substrate 604 following a helical (clockwise or counter-clockwise) pattern. A second phasing section 660 is preferably realized by mirroring the first phasing section 650 about a vertical plane crossing the rotation axis 120, so that phasing sections 650 and 660 are separated through capacitive gaps 601 and 607. The second bifilar arm 608 is also preferably realized by mirroring the first arm 606 about the same plane, and is coupled to second phasing section 660. Capacitive gaps 601 and 607 do not need to be identical, and the corresponding capacitances can be synthesized through edge coupling as in FIG. 6 or other means, for example through interdigitated capacitors. Also, bifilar arms 606 and 608, as well as phasing sections 650 and 660 do not need to be exact mirror replicas because in some instances it would be desirable to introduce asymmetries to compensate for the overall antenna asymmetry about said mirror plane (for instance, the vertical section 640 is only on one side of said plane). For instance, it is possible that phasing section 650 extends for more than half a circumference around substrate 604 while consequently phasing section 660 extends for less than half a circumference around substrate 604.

Because the electrical charges on opposite sides of the capacitive gaps feature opposite signs, it also follows that as the bifilar structure approaches resonance (whose frequency depends mainly on the length and pitch of the bifilar arms, the value of the gap capacitances, and the diameter of substrate 604) the bifilar arms also feature opposing currents and charges, thus realizing a differential behavior that results in the desired radiation pattern characteristics. Said pattern characteristics may be quantified in terms of a so-called upper-hemisphere efficiency (UHE), which represents the share of input power into the antenna structure that is radiated towards the upper hemisphere (directions belonging to the y>0 half space. For Satellite communications, higher UHE typically results in better, more reliable system performance.

Here again in accordance with some embodiments, the bifilar antenna 602 rotates about the axis of circumferential rotation 120 in response to the knob housing (not shown) being rotated. As mentioned previously, the substrate 604 may be formed as part of a knob housing or as a separate piece part (shown).

Accordingly, there has been provided a rotary control having at least one antenna radiating element integrated therein. The ability to integrate a variety of different antenna radiating elements along with a rotatable antenna feed electrode within the rotary control (either into the knob housing or as part of a substrate and knob housing) provides reliable electromagnetic feed for single, dual band or multiband operation. For instance, considering the meander monopole illustrated in FIGS. 2-3, it is clearly possible to add multiple non-intersecting meander monopoles, for example a combination of straight monopoles, meander monopole, and tapered monopoles on substrate 204, such as by positioning them around the perimeter of substrate 204. These antenna elements may have individual rotatable antenna feed electrodes or share the same rotatable antenna feed electrode 230. Following this approach, the described structure may be designed to operate in multiple transmit and receive bands thereby providing an advantageous method to collocate multiple antennas without interfering with the radio physical user interface.

When coupled to a communication device, the rotary control provides at least one communication device control function in addition to one or more antenna radiating elements. Thus, transmission and reception of RF signals can take place via the antenna radiating element while the rotary control can be simultaneously adjusted for such communication device functions as volume adjustment, channel change, power on/off, to name a few. The various embodiments for the rotary control having integrated antenna facilitate the ability of two way radio communication devices to accommodate a plurality of various RF technologies for wireless communication (e.g NFC, BLUETOOTH, WLAN, LTE, GPS to name a few).

Developments in the LDS, print and plate technologies and the like also allow for integration of the platform and stationary capacitive feed electrode into a single part with attachment to the feed line. The overlap of the stationary capacitive feed electrode and rotatable antenna feed electrode can be designed to provide capacitance large enough relative to possible variations due to mechanical tolerances or contamination in the field. The antenna radiating element within the knob housing can be realized through either LDS (or similar technology) or through the use of heat staked, overmolded, or otherwise attached material capable of carrying RF currents with low electromagnetic power loss. In other embodiments, two planar electrodes may be used to feed and receive the RF energy from radio to knob housing has also been disclosed.

The design of rotary controls can be easily adapted to integrate the antenna structures described herein due to location on the housing, form factor, distance from main radio mass, and ease of integration. Unlike past structures that have used a mechanical knob as a cover for an antenna residing in the hollow volume of the center of the knob, the rotary control of the various embodiments utilizes the capacitive feed design which permits the knob housing to operate as part of the antenna, while preserving the favorable mechanical features of a non-hollow knob, such as robustness, since for instance two-way radio knobs being so prominently located on the radio control top are subject to traumatic mechanical events such as radio drops.

The various embodiments have provided for a reliable electromagnetic feed for an antenna embedded within a rotary control. The rotary control having the antenna integrated therein formed in accordance with the various embodiments, eliminates the need to provide a galvanic rotary physical contact thereby reducing environmental wear and reliability risks to the knob housing thereby providing a robust and durable device.

Designing and feeding the antenna as part of the knob reduces cost, complexity, and improves performance by further moving the antenna away from the main metal mass (i.e. the chassis) of the communication device. The rotary control having integrated antenna of the various embodiments advantageously allows for preferred placement of the antenna on a radio control top, thereby freeing other portions of the two-way radio from cumbersome antenna structures, making the radio smaller and lighter, thus more user-friendly.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A rotary control, comprising:
a knob housing providing an axis of circumferential rotation; and
an antenna radiating element located within the knob housing, the antenna radiating element being rotatable along the axis of circumferential rotation in response to rotation of the knob housing.

2. The rotary control of claim 1, further comprising:
a rotatable antenna feed electrode coupled to the antenna radiating element.

3. The rotary control of claim 1, wherein the knob housing is formed of a plastic piece part and the antenna radiating element is disposed on or molded within the plastic piece part.

4. The rotary control of claim 1, further comprising:
a substrate assembled within the knob housing, the substrate being shaped to conform to an interior surface of the knob housing, wherein the antenna radiating element is disposed on or within the substrate, the substrate being rotatable along the axis of circumferential rotation in response to rotation of the knob housing.

5. The rotary control of claim 3, wherein the knob housing and substrate are molded as a single piece part and the antenna radiating element is embedded within the molded single piece part.

6. The rotary control of claim 1, wherein the substrate is non-hollow.

7. The rotary control of claim 1, wherein the antenna radiating element comprises an arbitrarily shaped monopole antenna.

8. The rotary control of claim 1, wherein the antenna radiating element comprises a bifilar antenna.

9. A rotary control, comprising:
a knob housing providing an axis of circumferential rotation;
a substrate disposed within the knob housing;
an antenna radiating element disposed within the substrate; and
wherein the antenna radiating element and substrate are rotatable along the axis of circumferential rotation of the knob housing.

10. The rotary control of claim 8, further comprising:
a rotatable antenna feed electrode coupled to the antenna radiating element, the rotatable antenna feed electrode being concentric with the axis of circumferential rotation of the knob housing.

11. The rotary control of claim 1, wherein the antenna radiating element comprises an arbitrarily shaped monopole antenna.

12. The rotary control of claim 1, wherein the antenna radiating element comprises a bifilar antenna.

13. A communication device, comprising:
a communication device housing;
a rotary control mounted to the communication device housing, the rotary control comprising:
a knob housing;
an antenna radiating element located within the knob housing; and
a rotatable antenna feed electrode coupled to the antenna radiating element, wherein the rotatable antenna feed electrode and the antenna radiating element coupled thereto are rotatable in response to the knob housing being rotated.

14. The communication device of claim 13, further comprising:
a control top upon which the rotary control is attached, the control top comprising:
a non-conductive platform;
a radio frequency (RF) feed line disposed on the non-conductive platform; and
a stationary capacitive feed electrode coupled to the RF feed line, the stationary capacitive feed electrode being concentric and at least partially overlapping with the rotatable antenna feed electrode providing for capacitive coupling therebetween.

15. The communication device of claim 14, wherein the knob housing rotates about an axis of circumferential rotation, and wherein the antenna radiating element and rotatable antenna feed electrode rotate about the axis of circumferential rotation in response to the knob housing being rotated.

16. The communication device of claim 14, wherein the capacitive coupling is maintained regardless of the rotary control position.

17. The communication device of claim 13, wherein the antenna radiating element comprises at least one of: an arbitrarily shaped monopole antenna, or a bifilar antenna.

18. The communication device of claim 13, wherein the antenna radiating element is operational at one or more of: single band, dual band or multi-band frequency operation.

19. The communication device of claim 13, wherein a plurality of antenna radiating elements, featuring individual rotatable antenna feed electrodes, are disposed to effect dual band or multi-band frequency operation.

20. The communication device of claim 13, wherein a plurality of antenna radiating elements, featuring shared rotatable antenna feed electrodes, are disposed to effect dual band or multi-band frequency operation.

21. The communication device of claim 13, wherein the rotary control provides at least one radio control function in addition to the antenna radiating element.

22. The communication device of claim 21, wherein the at least one radio control function comprises one or more of: volume adjustment, channel change, power on/off.

23. The communication device of claim 13, wherein the communication device comprises a two-way radio.

24. The communication device of claim 13, further comprising:
a radio frequency (RF) feed line; and
a stationary capacitive feed electrode coupled to the RF feed line, the stationary capacitive feed electrode and the rotatable antenna feed electrode being overlapping and planar to each other.
